(19) United States
(12) Patent Application Publication
(10) Pub. No.: US 2012/0197801 A1
(43) Pub. Date: Aug. 2, 2012

(54) MERCHANT PAYMENT SYSTEM AND METHOD FOR MOBILE PHONES

(76) Inventor: Day Jimenez, Miami, FL (US)

(21) Appl. No.: 13/359,234

(22) Filed: Jan. 26, 2012

Related U.S. Application Data
(60) Provisional application No. 61/436,971, filed on Jan. 27, 2011.

(51) Int. Cl. G06Q 20/40

(52) U.S. Cl. 705/44

(57) ABSTRACT

A method and system for processing a payment for a transaction with a merchant by a customer via a customer's mobile phone is disclosed. The method and system utilizes a customer mobile identifier comprised of an Issuer's BIN and the customer's telephone number. The merchant enters a customer's mobile phone number into the POS terminal and a transaction amount. This generates a transaction authorization request message in the POS terminal. The request is sent to the customer's mobile phone. The customer then selects a funding account. The amount and merchant's authorization request is then sent to the funding institution to authorize the transaction. Upon verification of account balance, the institution debits the funding account, and sends an approval message to both the customer's mobile phone and to the merchant's POS terminal.

### CROSS REFERENCE TO RELATED APPLICATIONS

This application claims the benefit of priority of U.S. Provisional Patent Application Ser. No. 61/436,971, filed Jan. 27, 2011, entitled Merchant Payment System and Method for Mobile Phones, the content of which is hereby incorporated by reference in its entirety.

### BACKGROUND

1. Field

The present disclosure generally relates to financial transaction systems and methods and more particularly to a computerized system and method for processing customer/merchant financial transactions utilizing mobile phones.

2. Description of Related Art

Several mobile payment initiatives have been implemented in different parts of the world using various mobile payment technologies and methods which mostly require sophisticated handsets (e.g. smart phones), mobile communication components (e.g. NFC) and SIM/chip technologies, with the ability to use WAP/Internet facilities to perform financial transactions and other mobile services in a mobile commerce economy. However, the globalization of these mobile payment solutions is still limited by certain market conditions, cost of compatible mobile devices and services, availability of funding sources, and network/acquirer infrastructure. The convergence of mobile and payment has proven to be a complex undertaking, requiring the association and cooperation of multiple business players and partners. What is needed is a simple, straightforward system and method for utilizing existing phone technology and existing payment processing system capabilities cooperating to facilitate transactions at a point of sale, i.e., directly at the merchant location.

### SUMMARY

The present disclosure utilizes a customized Point-of-Sale (POS) terminal using the GSM (Global System for Mobile communications) USSD (Unstructured Supplementary Service Data) capability that exists in current mobile phones.

The present disclosure provides a simple and secure process solution that integrates standard, readily available mobile technologies (e.g., GSM USSD) with business stakeholders (e.g., merchants, banks, etc) to enable customer payments in a seamless and effective manner through the use of a unique mobile payment system and an enhanced point of sale software application.

One embodiment of a method of processing a payment for a transaction with a merchant by a customer via a customer's mobile phone includes the following operations: providing a point of sale (POS) terminal at a merchant location; entering a customer's mobile phone number into the POS terminal; entering a transaction amount into the POS terminal; generating a transaction authorization request message in the POS terminal; and sending the transaction authorization request to the customer's mobile phone.

When the customer receives a USSD push message containing the transaction authorization request, the customer must accept or reject the request for authorization. The customer then selects a funding account on his/her mobile phone. The mobile phone then automatically transmits via the preferably encrypted telephone number associated with the funding account, the customer's Personal Identification Number (PIN) associated with the funding account, the transaction amount, and the authorization request to the funding institution to authorize the transaction. Upon verification of account balance, the institution debits the funding account, and sends an approval message to both the customer's mobile phone and to the merchant via the POS terminal.

In one embodiment the transaction authorization request message includes the payer identifier and the transaction amount. The POS terminal generates a mobile identifier comprising the Issuer's Bank Identification Number (BIN) and the customer's 10 digits mobile phone number. Note that the BIN is not a customer related identifier. Instead, the POS is configured to use an issuing tPago bank mobile payment system BIN.

Preferably the sending operation further comprises transmitting the authorization request to the customer's mobile phone via an acquirer network to a tPago mobile payment system which translates the unique mobile ID numbers and amount to the required format for transmission through the mobile network operator back to the customer's mobile phone. The customer selects the desired funding account and his/her mobile phone automatically sends the authorization request through the mobile network operator to the tPago mobile payment system. The tPago mobile payment system then routes the authorization request to the customer's bank or financial institution for authorization of payment.

When authorization by the bank is given, the customer's account is debited, and an approval message is generated which is sent via the tPago Mobile Payment system and Mobile network operator back to the customer's mobile phone. Similarly, an approval message is generated and sent through the acquirer network back to the merchant's POS terminal. Finally, a record of the transaction is stored in the Mobile Payment System for reconciliation and settlement purposes or may optionally be stored in a centralized bank database.

The tPago mobile payment system in accordance with the present disclosure communicates with the customer via a mobile network operator. The mobile payment system communicates with a merchant's point of sale (POS) terminal via the Merchant Acquirer Network and with a customer's mobile phone via the Mobile network Operator. The tPago mobile payment system facilitates communication via secure VPN links to the designated central bank, if any, and customer's banks or other financial institution containing the funding accounts.

In one embodiment, the method of processing a payment for a transaction with a merchant by a customer via a customer's mobile phone includes providing a point of sale (POS) terminal at a merchant location entering a customer's mobile phone number into the POS terminal, entering a transaction amount into the POS terminal, and generating a transaction authorization request message in the POS terminal. The method further includes sending the transaction authorization request to the customer's mobile phone, and generating a USSD push live session on the customer's mobile phone. The user then selects a funding account on the customer's mobile phone, transmits via the mobile phone the customer's alias for his funding account number, the customer's encrypted PIN, the transaction amount, and authorization request to the funding institution to authorize the transaction. Upon verification of the account and the account balance, the Bank debits the funding account; and sends an approval message to the customer's mobile phone and to the merchant via the POS terminal.

The transaction authorization request message preferably includes a mobile identifier comprising an Issuer's BIN and a 10 digit mobile telephone number. This mobile telephone number is the customer's mobile phone number.

One system in accordance with the disclosure may involve processing a payment for a transaction with a merchant by a customer via a customer's mobile phone. In particular, the system preferably includes means for providing a point of sale (POS) terminal at a merchant location having stored therein an identifier unique to the merchant, means for entering a customer's mobile phone number into the POS terminal, means for entering a transaction amount into the POS terminal, and means for generating a transaction authorization request message in the POS terminal.

The system further preferably includes means for sending the transaction authorization request to the customer's mobile phone, means for generating a USSD push live session on the customer's mobile phone, means for selecting a funding account on the customer's mobile phone, means for transmitting via the mobile phone the funding account number, PIN, amount, and authorization request to the funding institution to authorize the transaction, means for debiting the funding account upon verification of account balance; and means for sending an approval message to the customer's mobile phone and to the merchant via the POS terminal.

### BRIEF DESCRIPTION OF THE DRAWINGS

FIG. 1 is a schematic representation of the tPago Mobile Payments System platform at the center of the Stakeholders Mobile Payments Ecosystem with the various communication interfaces and mobile protocols used to interact with the business partner applications.

FIG. 2 illustrates the end-to-end tPago Mobile Payments transaction flow from the time that the customer/mobile phone initiates the transaction at the merchant POS location until it receives the confirmation messages (USSD/SMS) and POS prints the sales voucher.

FIG. 3 shows the sequence of POS screens that are prompted by the merchant POS device to capture and execute a payment transaction through the acquirer network in accordance with the present disclosure.

FIG. 4 depicts the tPago Mobile ID composition which includes the Issuer's Bank Identification Number (BIN) and the customer's Mobile Telephone Number.

FIG. 5 illustrates the sequence of USSD screens that are prompted on the mobile phone to a mobile phone user as part of the USSD session and customer interaction to execute a payment transaction.

FIG. 6 is an operational flow diagram showing the sequential operations conducted in processing a financial transaction in accordance with the present disclosure.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

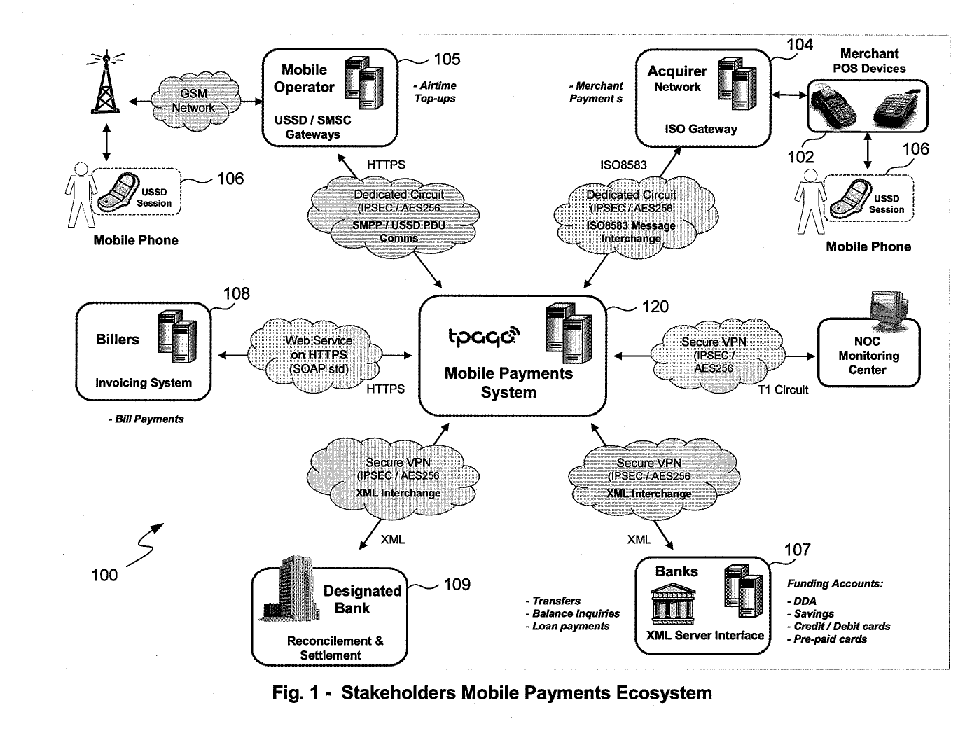

The present disclosure provides a unique process and method that enables mobile payment transactions to flow seamlessly between the customer's mobile phone, the Merchant POS/acquirer network 104, the Mobile Network Operator 105 and Financial institutions 107 which are an integral part of an established Stakeholders Mobile Payments Ecosystem 100. A Stakeholders Mobile Payments Ecosystem 100 that incorporates a system in accordance with the present disclosure is depicted in FIG. 1 (e.g. mobile network operator 105, merchant 102, acquirer 104, bank 107, billers 108, payment processor) all feeding through the tpago mobile payments system 120.

In the present disclosure, the mobile phone 106 acts like a single device that can handle multiple accounts from multiple issuing institutions, like banks and card issuers. In other words, the solution in accordance with the present disclosure provides the means to link the mobile phone number or Payer ID (unique payment identifier) to customer accounts from various funding sources (demand deposit account (DDA), savings, debit/credit card, pre-paid accounts) via a particular structure called the tPago Relationship Structure. This structure is external to the mobile phone handset 106. It avoids the need to build or store sensitive data in the mobile device. In this schema, the mobile phone becomes an electronic payment instrument which ultimately, will lead to a substantial reduction in user's dependency on cards/plastics, bank checks and possibly cash, thus strengthening customer security and fraud prevention efforts.

An important enabler of the system and method of this disclosure is the existing technology behind the mobile phone 106 and network operator 105 gateway infrastructure. This is the USSD protocol (Unstructured Supplementary Service Data protocol). The USSD protocol is a session-based communication channel exclusive to the GSM standard that is leveraged to interact with the acquirer/merchant POS software and the tPago Mobile Payments System 120 to facilitate financial transactions. Moreover, within the USSD capabilities, the present disclosure uses a particular component, the USSD Push, which is a network-generated request that automatically prompts information on the customer mobile phone screen to begin a real-time session.

The application engine in this disclosure that integrates the stakeholders mobile payment ecosystem 100 with the mobile technologies (USSD, SMS) is the tPago Mobile Payments System 120 which acts as the focal point for message exchanges and translations between the tPago mobile payments system 120 and the stakeholders systems. Various messaging standards are used to communicate with the stakeholders. The ISO 8583 format is preferably used, for example at the merchant Point-of-Sale (POS) terminal 102 and acquirer systems 104. This ISO 8583 standard defines a message format and a communication flow so that different systems can exchange transaction requests and responses. For example, both the MasterCard and Visa networks base their authorization communication on the ISO 8583 standard, as do many other institutions and networks.

The XML (eXtensible Markup Language) based-format is used for banks and mobile network operator exchanges, and the HTTPS (Hypertext Transfer Protocol Secure) format is used for message exchanges with billers via the Internet. (Web Services interface). The tPago Mobile Payment transaction in accordance with the present disclosure combines all of the above formats (ISO8583, XML, HTTPS) in an end-to-end transaction.

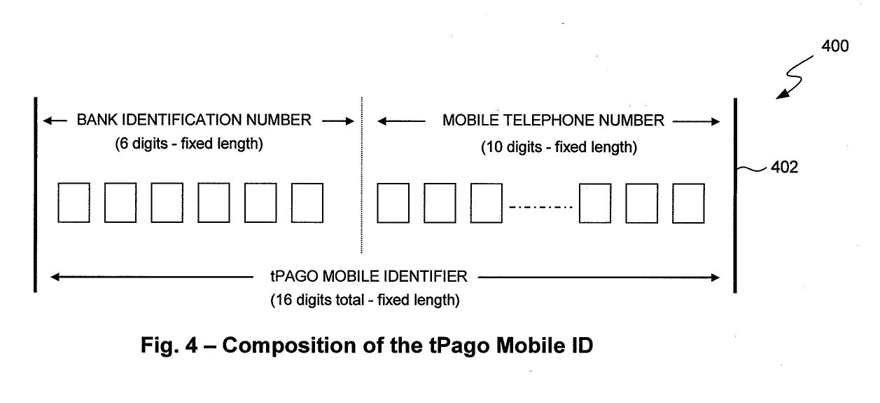

The method disclosed herein uses (1) mobile phone 106 data (e.g. customer's mobile phone number) and Point-of-Sale software logic to construct a special data combination over the ISO 8583 format, (2) the tPago Mobile ID (similar to the ISO Primary Account Number field) 402 that permits the cross-referencing of critical elements in the tPago Relationship Structure (customer ID, phone number, account number aliases) with (3) funding accounts to perform merchant payment operations like authorizations, debits/credits, transaction identification, and settlement. As well, within this special data structure 400 (FIG. 4), tPago utilizes an ISO BIN (Bank Identification Number) which allows the issuance of a private label virtual card.

This 6-digit ISO BIN in combination with the customer's 10-digit telephone number forms the special 16-digit tPago Mobile ID numbers 402. The tPago Mobile ID number 402, becomes a singular mechanism that facilitates mobile payment transactions across the Acquirer network to and from the financial institutions in accordance with the present disclosure. The unique 16 digit number 402 is made up of the Issuer's ISO bank identification number (BIN) and the customer's mobile telephone number. This 16 digit number 402 is thus unique both to the customer's account and his or her phone. The “Issuer” is the bank or institution that generates the virtual debit account.

The end-to-end process in accordance with the present disclosure preferably takes advantage of key mobile and network technologies namely the USSD protocol and network-generated USSD Push feature to provide a special customer experience for exchanging information to facilitate real-time/online payments.

The tPago Mobile ID 402. serves as the major linking mechanism (virtual card) between the customer, merchant POS device 102, acquirer network 104, mobile network operator 105 and financial institutions 107, 109. This key element of the present disclosure along with the particular tPago Relationship Structure (Customer ID, Mobile number, account alias) provides the means to access multiple funding sources and other related functionalities and services like fund transfers, airtime top-ups, bill payments, etc.

At the center of the Stakeholders Mobile Payments Ecosystem 100 is the tPago Mobile Payments System 120 which has been architected to integrate all the different message formats, protocols and gateways (USSD, SMS, ISO 8583, XML, HTTP) in a single end-to-end payment transaction to successfully communicate with the different stakeholder application systems. In addition, the tPago Mobile Payment System 120 will perform all necessary daily processes to reconcile & settle with business partners and optionally a designated bank 109.

The tPago USSD Merchant Payment Method in accordance with the present disclosure is designed to perform merchant payment transactions at POS locations using the customer's mobile phone capabilities as a monetary instrument. The major operational steps are: (1) initiate and send payment transaction through POS device, (2) approve the mobile payment transaction, (3) notify customer of transaction status via USSD and SMS channels, and (4) reconcile/settle with the acquirer and bank. A detailed description of each of these follows:

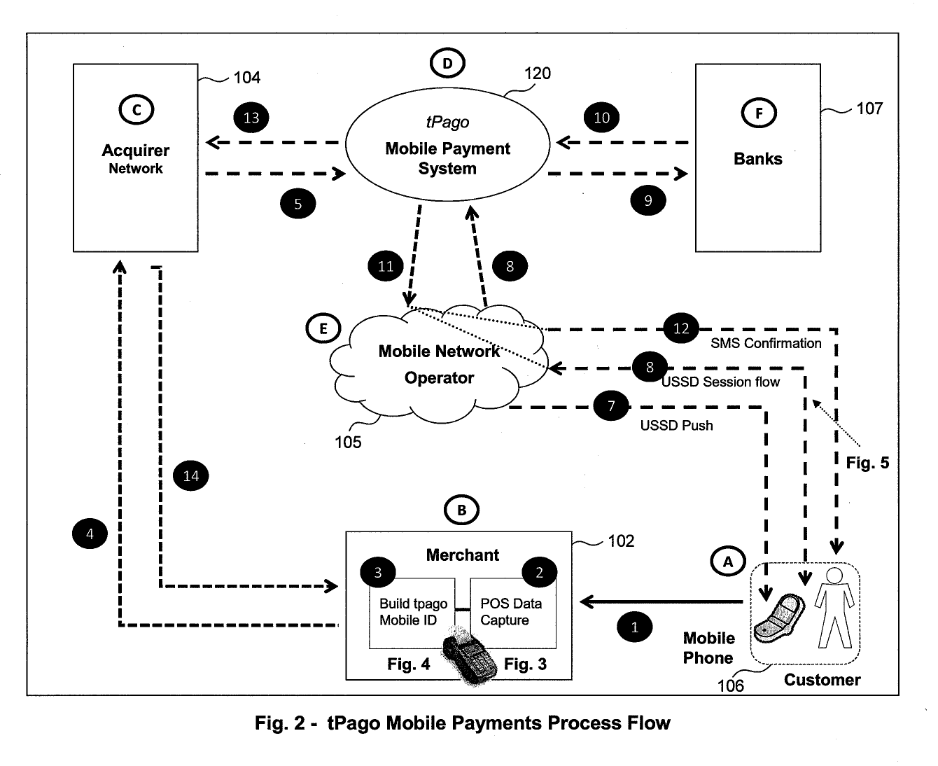

FIG. 2 illustrates the elements of the present disclosure that comprise the overall end-to-end process. These elements are: the Mobile Phone 106 (A), the Merchant location 102 for POS capture (B), the Acquirer 104 for payment network switching (C), the tPago Mobile Payment System 120 that synchronizes all exchanges and validations with stakeholder applications (D), the Mobile Network Operator 105 that handles the mobile device USSD session and SMS communications (E), and the Banks 107 which handle all requests for financial authorizations (F).

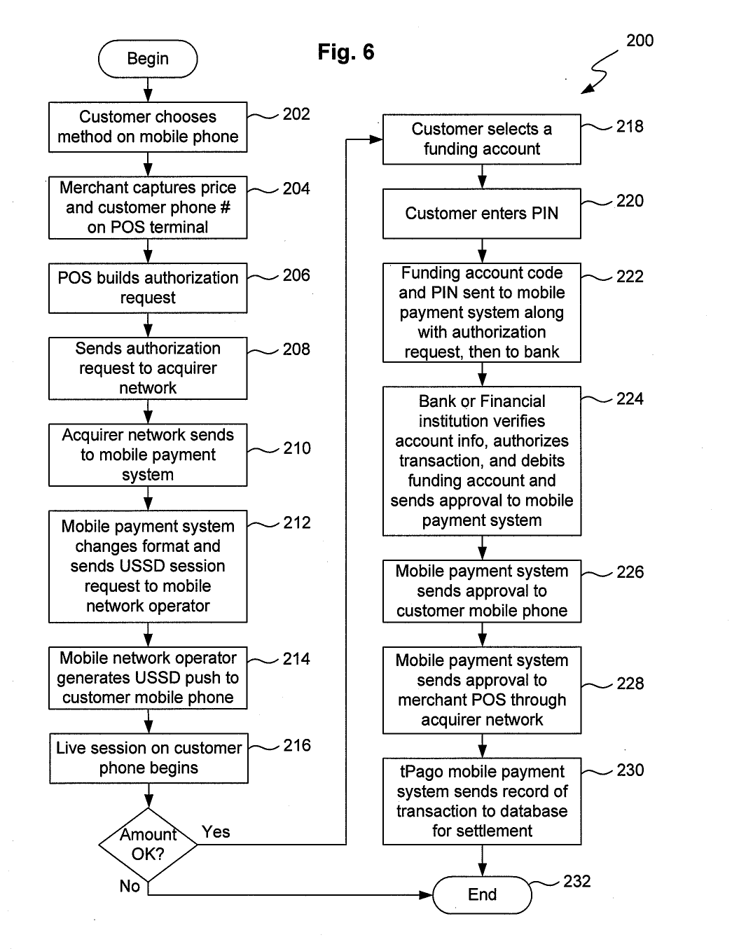

Detailed end-to-end process flow is shown in FIG. 6. This process 200 begins when the customer opts for the tPago mobile payment method using mobile device 106 (at 1) in operation 202.

Control then transfers to operation 204. In operation 204, the merchant 102 captures the customer's data (mobile phone number and the transaction amount) via POS device 102. This operation may be manually performed or may alternatively be wirelessly transmitted to the POS 102 from the customer's mobile phone 106. Control then transfers to operation 206, where the POS program software in POS terminal 102 builds (3) an ISO 8583 message which includes the tPago Mobile ID field elements 404 as is shown in the lower portion of FIG. 4 for the merchant, as well as the customer's tPago Mobile ID 402. Control then transfers to operation 208.

In operation 208, the POS terminal sends the authorization request (4) is sent to the Acquirer network 104. Control then transfers to operation 210. In operation 210, the Acquirer network (Switch) identifies the request and routes (5) the message (customer's mobile phone number, amount, merchant tPago mobile identifier) to the tPago Mobile Payments System 120. Control then transfers to operation 212.

In operation 212, the tPago Mobile Payment System 120 prepares the HTTPS message format, and initiates the USSD request by sending the transaction data to the Mobile Network Operator 105. Control then transfers to operation 214.

In operation 214, the Mobile Network Operator 105 generates the USSD Push (7) on the customer's mobile phone 106 triggering a USSD “live” session 216 with the Customer on the customer's mobile phone 106. During the USSD session 216 interaction (Mobile phone, Mobile Network Operator and tPago Mobile Payment System), the mobile phone displays the transaction amount and the registered account, or, if more than one account, a listing of registered accounts. If the amount is acceptable, Control then transfers to operation 218.

In operation 218, the customer selects one of the tPago registered accounts. Control then transfers to operation 220 where the customer enters a PIN (Personal Identification Number) for that particular account. Preferably an encrypted representation of the account No. and PIN are then sent from the customer's mobile phone via the mobile network operator 105 to the tPago Mobile Payment System 120. Control then transfers to operation 222.

In operation 222, the tPago Mobile Payment System 120 prepares and sends an XML request (9) for authorization to the customer's Bank 107 (account alias and amount). Control then transfers to operation 224.

In operation 224, the customer's Bank 107 verifies the account information, authorizes the transaction, debits the funding account and transmits (10) the authorization number to the tPago Mobile Payments System 120. Control then transfers to operation 226. Here, the tPago Mobile Payment System 120, via the Mobile Network Operator 105 (USSD session), sends the approval message to the Customer's Mobile phone 106 (11) (8) and an SMS confirmation message (11) (12) to the phone 106. Control then transfers to operation 228.

In operation 228, the tPago Mobile Payment System 120 sends the approval message (13) to the Acquirer network 104 which forwards the approval and confirmation message to the Merchant POS device 102 and the corresponding vouchers are optionally printed (14). Control then transfers to operation 230 where the merchant payment transaction is recorded in the tPago Mobile Payment database for backend reconcilement & settlement processes with the appropriate acquirers and banks. Control then transfers to end operation 232 where the transaction process terminates.

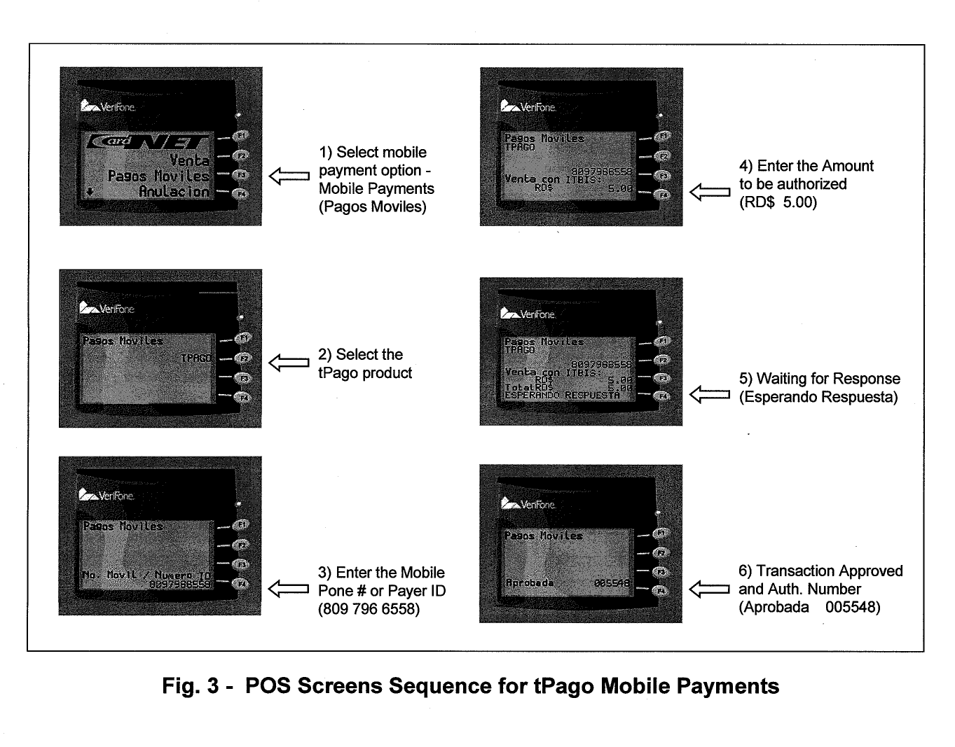

FIG. 3 shows a set of point of sale terminal display screens that correspond to the process shown and described above with reference to FIG. 6. At screen 1), the POS screen shows selection of the mobile payment process. The merchant presses F3 to select mobile payment. The screen 2) then shows the tPago system for mobile payments. The merchant then presses F2 to select the tPago system. The merchant then enters, at 3), the customer's mobile phone number and presses F4. The merchant then enters the amount to be authorized, and again presses F4. Screen 5 illustrates the POS display during the process of transmission through the tPago system 120 to the funding bank 107. When an approval is received back at the POS terminal, the approval number is displayed to the merchant on the POS terminal at screen 6.

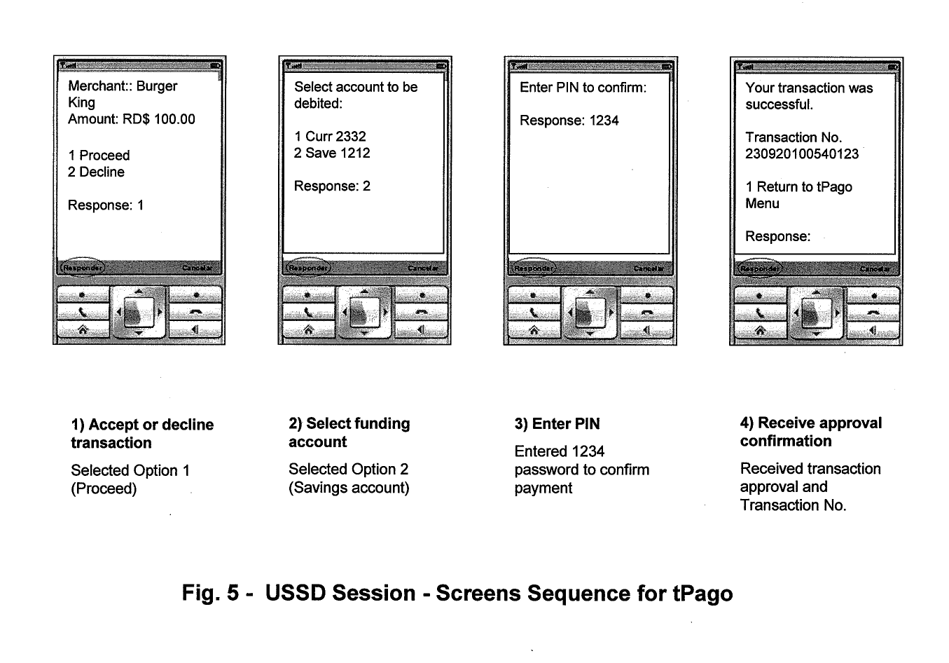

Turning now to FIG. 5, a set of exemplary customer's mobile phone displays is shown to illustrate the transaction process. At 1) the customer's phone displays the merchant name, and amount for the transaction and asks whether to proceed or decline. At 2) the display shows the customer the list of accounts from which the funds may be debited. At 3), the customer has selected #2. The customer is prompted for his/her PIN. At 4) the customer's phone display shows the transaction number, and indicates that the transaction was successful.

It is clear that many modifications and variations of this embodiment may be made by one skilled in the art without departing from the spirit of the novel art of this disclosure. In particular, in addition to electronic communication means such as email, SMS, IM, etc., messages may also be exchanged by means of a voice XML or IVR system or other, similar automated voice telephone system. In other cases, other suitable, similar messaging media or web interfaces may be offered for interaction with the system to achieve an exchange of information. These variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A method of processing a payment for a transaction with a merchant by a customer via a customer's mobile phone, the method comprising:
providing a point of sale (POS) terminal at a merchant location having stored therein a mobile identifier unique to the merchant;
entering a customer's mobile phone number into the POS terminal;
entering a transaction amount into the POS terminal;
generating a transaction authorization request message in the POS terminal;
sending the transaction authorization request to the customer's mobile phone;
generating a USSD push live session on the customer's mobile phone;
selecting a funding account on the customer's mobile phone;
transmitting via the mobile phone the funding account number, a customer's personal identification number (PIN), the transaction amount, and the authorization request to a funding institution to authorize the transaction;
upon verification of account and sufficient account balance, the institution debiting the funding account; and
sending an approval message to the customer's mobile phone and to the merchant via the POS terminal.

2. The method of processing according to claim 1 wherein the transaction authorization request message includes the mobile identifier and the transaction amount.

3. The method of processing according to claim 1 wherein the mobile identifier includes the customer's mobile phone number.

4. The method of processing according to claim 1 further comprising generating in the POS terminal a mobile identifier comprising an Issuer's bank identification number (BIN) and the customer's mobile phone number.

5. The method of processing according to claim 4 wherein the POS terminal mobile identifier comprises the Issuer's BIN and the customer's 10 digit mobile telephone number.

6. The method of processing according to claim 1 wherein the selecting operation includes generating a customer mobile identifier comprising a customer's BIN and mobile phone number.

7. The method of processing according to claim 6 wherein the POS terminal mobile identifier comprises an Issuer's BIN and the customer's mobile telephone number.

8. The method of processing according to claim 6 wherein the sending operation further comprises transmitting the authorization request to the customer's mobile phone via an acquirer network.

9. A system for processing a payment for a transaction with a merchant by a customer via a customer's mobile phone, the system comprising:
means for providing a point of sale (POS) terminal at a merchant location having stored therein a payer identifier unique to the merchant;
means for entering a customer's mobile phone number into the POS terminal;
means for entering a transaction amount into the POS terminal;
means for generating a transaction authorization request message in the POS terminal;
means for sending the transaction authorization request to the customer's mobile phone;
means for generating a USSD push live session on the customer's mobile phone;
means for selecting a funding account on the customer's mobile phone;
means for transmitting via the mobile phone the funding account number, the customer's personal identification number (PIN), transaction amount, and the authorization request to the funding institution to authorize the transaction;
means for debiting the funding account upon verification of account balance; and
means for sending an approval message to the customer's mobile phone and to the merchant via the POS terminal.

10. The system according to claim 9 wherein the mobile identifier includes a customer's mobile phone number.

11. The system according to claim 9 further comprising means for generating in the POS terminal a mobile identifier comprising an Issuer's bank identification number (BIN) and the customer's mobile phone number.

12. The system according to claim 9 wherein the means for selecting includes generating a customer mobile identifier comprising a customer's BIN and mobile phone number.

13. A machine-readable tangible medium having stored thereon a set of instructions which when executed perform a method comprising:
providing a point of sale (POS) terminal at a merchant location having stored therein a mobile identifier unique to the merchant;
entering a customer's mobile phone number into the POS terminal;
entering a transaction amount into the POS terminal;
generating a transaction authorization request message in the POS terminal;
sending the transaction authorization request to the customer's mobile phone;
generating a USSD push live session on the customer's mobile phone;
selecting a funding account on the customer's mobile phone;
transmitting via the mobile phone the funding account number, a customer's personal identification number (PIN), the transaction amount, and the authorization request to a funding institution to authorize the transaction;
upon verification of account and sufficient account balance, the institution debiting the funding account; and
sending an approval message to the customer's mobile phone and to the merchant via the POS terminal.

14. The machine readable medium according to claim 13 wherein the transaction authorization request message includes the mobile identifier and the transaction amount.

15. The machine readable medium according to claim 13 wherein the mobile identifier includes the customer's mobile phone number.

16. The machine readable medium according to claim 13 further comprising generating in the POS terminal a mobile identifier comprising an Issuer's bank identification number (BIN) and the customer's mobile phone number.

17. The machine readable medium according to claim 16 wherein the POS terminal mobile identifier comprises the Issuer's BIN and the customer's 10 digit mobile telephone number.

18. The machine readable medium according to claim 13 wherein the selecting operation includes generating a customer mobile identifier comprising a customer's BIN and mobile phone number.

19. The machine readable medium according to claim 18 wherein the POS terminal mobile identifier comprises an Issuer's BIN and the customer's mobile telephone number.

20. The machine readable medium according to claim 18 wherein the sending operation further comprises transmitting the authorization request to the customer's mobile phone via an acquirer network.
